(19) United States
(12) Patent Application Publication
(10) Pub. No.: US 2024/0248677 A1
(43) Pub. Date: Jul. 25, 2024

(54) ENHANCEMENTS TO MODEMS AND GATEWAYS FOR VISUALLY IMPAIRED USERS

(71) Applicant: CenturyLink Intellectual Property LLC, Broomfield, CO (US)

(72) Inventor: Andrew CAREY, Junction City, OR (US)

(73) Assignee: CenturyLink Intellectual Property LLC, Broomfield, CO (US)

(21) Appl. No.: 18/419,448

(22) Filed: Jan. 22, 2024

Related U.S. Application Data
(60) Provisional application No. 63/481,168, filed on Jan. 23, 2023.

(51) Int. Cl. G06F 3/16; H04L 12/28; H04L 12/66

(52) U.S. Cl. CPC G06F 3/167; H04L 12/2898; H04L 12/66

(57) ABSTRACT

This disclosure describes systems, methods, and devices related to presenting audio announcements of customer equipment status. A device may identify a condition triggering an audio announcement of device or network status of customer equipment, wherein the customer equipment includes a modem or a gateway; generate, based on the identification of the condition, the audio announcement; and present, based on the identification of the condition, the audio announcement using a speaker.

### CROSS-REFERENCE TO RELATED APPLICATIONS

This application is related to and claims priority under 35 U.S.C. § 119(e) from U.S. patent application Ser. No. 63/481,168, filed Jan. 23, 2023, titled “ENHANCEMENTS TO MODEMS AND GATEWAYS FOR VISUALLY IMPAIRED USERS,” the entire content of which is incorporated herein by reference for all purposes.

### TECHNICAL FIELD

Embodiments of the present invention generally relate to devices, systems, and methods for enhancing modems and gateways for visually impaired users.

### BACKGROUND

Network services often include the use of customer equipment in a user's home, including modems and gateways. The equipment often uses lights to indicate device and network status to a user. However, such indicators may not be helpful to users who are visually impaired or who cannot see the lights based on where customer equipment is placed.

### SUMMARY

A device for presenting audio announcements of customer equipment status may include a speaker and memory coupled to at least one processor, the at least one processor configured to: identify a condition triggering an audio announcement of device or network status of customer equipment, wherein the customer equipment includes a modem or a gateway; generate, based on the identification of the condition, the audio announcement; and present, based on the identification of the condition, the audio announcement using the speaker. The condition may include a user request, a proximity detection, passing of a time period, and/or a detection of a changed status.

A system for presenting audio announcements of customer equipment status may include: a speaker; customer equipment in a network; and memory coupled to at least one processor, the at least one processor configured to: identify a condition triggering an audio announcement of device or network status of the customer equipment, wherein the customer equipment includes a modem or a gateway; generate, based on the identification of the condition, the audio announcement; and present, based on the identification of the condition, the audio announcement using the speaker. The condition may include a user request, a proximity detection, passing of a time period, and/or a detection of a changed status.

A method for presenting audio announcements of customer equipment status may include: identifying, by processing circuitry of a device, a condition triggering an audio announcement of device or network status of customer equipment, wherein the customer equipment includes a modem or a gateway; generating, by the processing circuitry, based on the identification of the condition, the audio announcement; and presenting, by the processing circuitry, based on the identification of the condition, the audio announcement using a speaker. The condition may include a user request, a proximity detection, passing of a time period, and/or a detection of a changed status.

### BRIEF DESCRIPTION OF THE DRAWINGS

FIG. 1 illustrates an exemplary system for presenting device and network audio status announcements in accordance with one embodiment.

FIG. 2 illustrates an exemplary system for presenting device and network audio status announcements based on user proximity in accordance with one embodiment.

FIG. 3A illustrates an exemplary system for collecting device and network status information and presenting device and network audio status announcements in accordance with one embodiment.

FIG. 3B illustrates an exemplary system for collecting device and network status information and presenting device and network audio status announcements in accordance with one embodiment.

FIG. 4 is a flowchart illustrating a process for presenting device and network audio status announcements in accordance with one embodiment.

FIG. 5 is a diagram illustrating an example of a computing system that may be used in implementing embodiments of the present disclosure.

### DETAILED DESCRIPTION

Aspects of the present disclosure involve devices, systems, methods, and the like, for enhancing customer equipment indicators for visually impaired users.

Customer equipment such as modems and gateway devices may communicate their status and the status of any networks (e.g., local area networks, etc.) with which they are associated. The status indicators often use lights to indicate whether a device is on, whether devices are connected (e.g., a physical layer connection), whether a Wi-Fi radio is active/connected, whether Internet is detected, whether wireless or wired connections are made, and the like.

Visually impaired users may be unable to see such visual indicators. In addition, if a device is placed somewhere where a user cannot easily see the visual indicators (e.g., behind an object, door, cabinet, etc.), a user may not easily see the visual indicators.

Therefore, enhancements to customer equipment status indicators may be beneficial.

In one or more embodiments, in place of or in addition to the visual status indicators, customer equipment may use audio indicators to announce a device's status (e.g., power on or off, wired or wireless connection in place or not, Wi-Fi radio is active or inactive, Internet detected, etc.). The audio indicators may be presented using a speaker on a device, whether a device announcing its status or a the status of a different device announcing status of another device (e.g., a device physically remote from the customer equipment whose status is being announced). For example, the audio output device used to present the audio indicators may be integrated into a customer equipment or may be a plug-in device that may be added to a customer equipment. Currently, some customer equipment do not include a speaker for audio outputs.

In one or more embodiments, a sensor (e.g., integrated into the customer equipment or the plug-in device) may detect a user's proximity to a customer equipment. Based on detection of a user's proximity to customer equipment, one or more audio indicators may be presented to indicate device/network status. In this manner, a user's proximity to a customer equipment may trigger the announcement of device/network status. Alternatively or in addition, device/network status may be announced periodically and/or based on status changes (e.g., device powering on or off, connections established/lost, Wi-Fi radio activated or deactivated, Internet detected or not, etc.). Alternatively or in addition, customer equipment may have a physical button (e.g., using Braille) that, when touched by a user, may cause a status announcement to be presented via audio. Alternatively or in addition, the status updates may be sent to connected devices (e.g., connected wirelessly or wired to a customer equipment/network facilitated by the customer equipment) and/or to user-selected devices for presentation. The proximity sensor and/or status button may be provisioned remotely, and/or turned off or on remotely.

In one or more embodiments, one device may receive the status of another device and announce the status on behalf of the other device. For example, a gateway separate from an access point may collect the status of one or more customer equipment in a person's home and present the audio status indicators on their behalf.

In one or more embodiments, the customer equipment may include, but is not limited to, digital subscriber line (DSL)/Gigabit Ethernet passive optical network (GPON)/XGSPON modems and gateways. Audio status indicators also may apply to non-gateway Wi-Fi and/or optical network terminal (ONT) devices.

In one or more embodiments, conditions triggering the generation and presentation of audio announcements of device and network status may include a user request (e.g., a pushing/touching of a button, a voice request, etc.), a detection of user proximity to a device, a passing of time (e.g., periodic reporting), and/or a detected status update for a device or network status.

The above descriptions are for purposes of illustration and are not meant to be limiting. Numerous other examples, configurations, processes, etc., may exist, some of which are described in greater detail below. Example embodiments will now be described with reference to the accompanying figures.

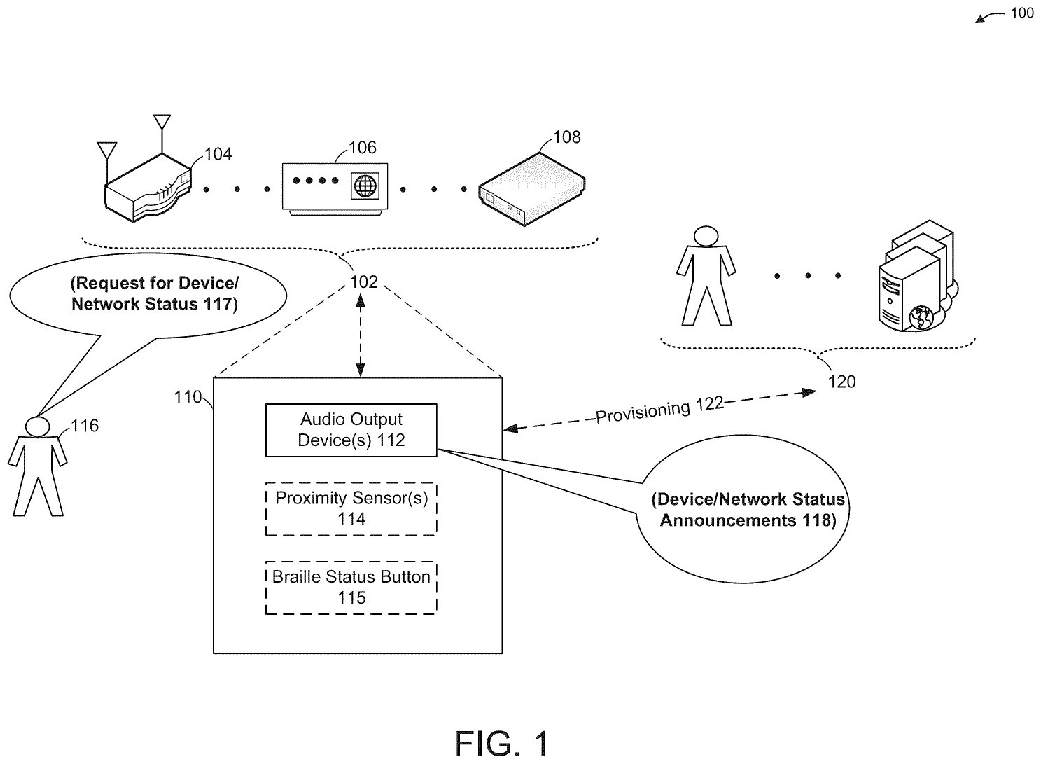

FIG. 1 illustrates an exemplary system 100 for presenting device and network audio status announcements in accordance with one embodiment.

Referring to FIG. 1, system 100 may include devices 102 (e.g., customer equipment including device 104, device 106, device 108, any of which may include gateways, modems, access points, and the like) which may include or be in communication with components 110 (e.g., which may form a separate device that may communicate wirelessly or wired with any of the devices 102), which may include one or more audio output devices 112 (e.g., speakers), one or more proximity sensors 114 (optionally), and one or more Braille status buttons 115 (optionally). The one or more proximity sensors 114 may detect a presence of a user 116 (e.g., within a threshold distance of the components 110 or the devices 102) and/or a user request for device/network status (e.g., a verbal request 117 and/or a touch/push of the Braille status button). In response to a triggering condition (e.g., passage of a time period, detection of proximity of the user 116, a request from the user 116, and/or a detected status change of any of the devices 102 or an associated network of the devices 102), the one or more audio output devices 112 may generate and present audio device/network status announcements 118 to indicate the device/network status. One or more remote resources 120 (e.g., humans and/or devices) may remotely provision 122 the components 110, such as during an installation/startup of any of the devices 102 and/or the components 110.

In one or more embodiments, the components 110 may be on-board any of the devices 102, or may represent one or more standalone devices that may connect (e.g., wired or wirelessly) to any of the devices 102. As a standalone device, the devices 102 may not need to be retrofitted with or replaced by new devices having the components 110.

In one or more embodiments, any of the devices 102 may send device/network status information to any of the devices 102 and/or to the components 110 (e.g., when the components 110 represent a separate device). In this manner, any of the devices 102 or the components 110 as a separate device may collect and report status information from any of the other devices 102. The devices 102 may send or present the device/network status information periodically or based on some other triggering condition, such as user proximity detection or user request for a status update. A device collecting the device/network status information of other devices may request the device/network status information based on such triggering conditions, or when a triggering condition is identified, may present the latest device/network status information that it has for itself and/or another device.

In one or more embodiments, the Braille status button 115 (or touchpad, etc.) may use Braille to indicate that when touched/pushed, the audio device/network status announcements 118 may be presented as a result to communicate status of a customer equipment or associated network or device.

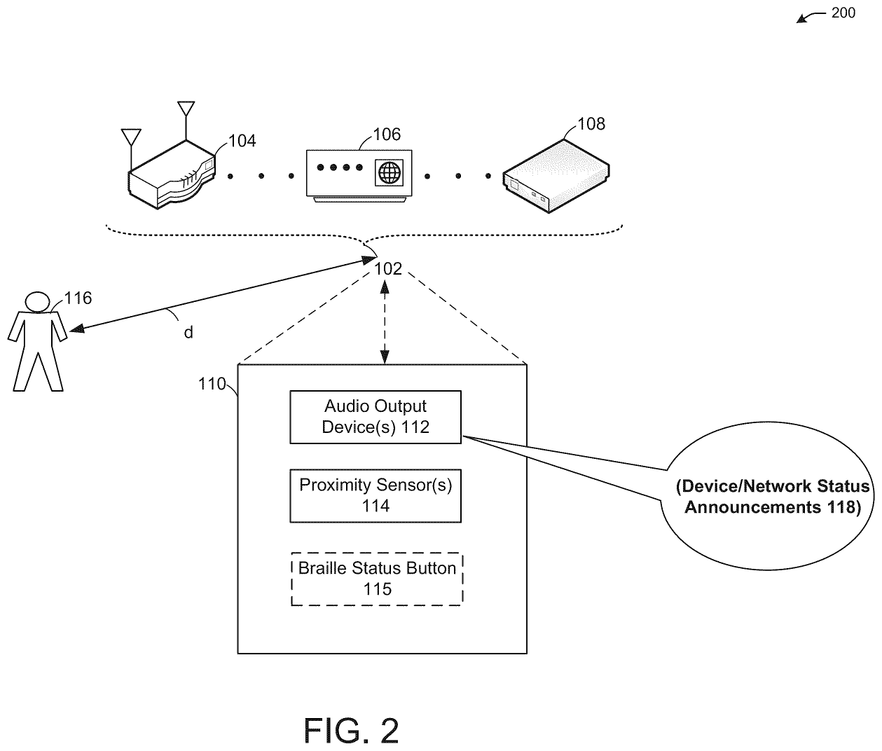

FIG. 2 illustrates an exemplary system 200 for presenting device and network audio status announcements based on user proximity in accordance with one embodiment.

Referring to FIG. 2, the system 200 may include the devices 102 and the components 110 of FIG. 1. In FIG. 2, the system 200 includes the one or more proximity sensors 114 as part of the devices 102 or a standalone device represented by the components 110. The proximity sensors 114 may detect when the user 116 is within a distance threshold (d) from the devices 102 or from the components 110, or when motion is detected within the distance threshold (d), such as when the devices 102 or the components 110 are behind a door, drawer, cabinet, or other object that is moved, indicating presence of the user 116. Proximity of the user 116 may indicate that the user 116 is approaching the devices 102 and/or the components 110 to receive a status update of devices or associated networks. In this manner, the proximity may represent a user request for a device/network status update. In response, the audio device/network status announcements 118 may be presented using the one or more audio output devices 112.

In one or more embodiments, the one or more proximity sensors 114 may include electromagnetic sensors, photoelectric sensors, inductive sensors, optical sensors, Hall effect sensors, sonar, radar, Doppler, or the like.

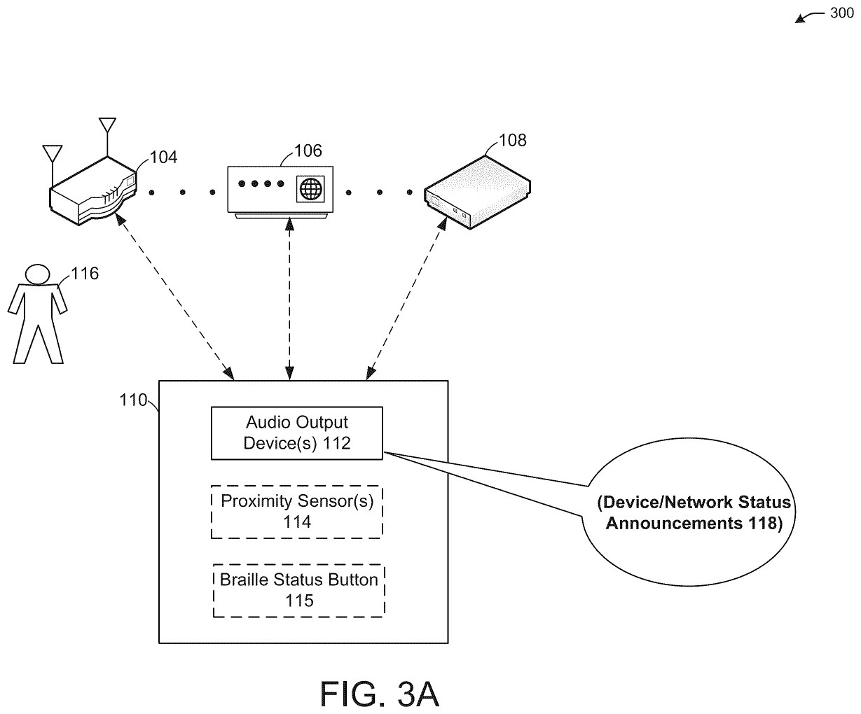

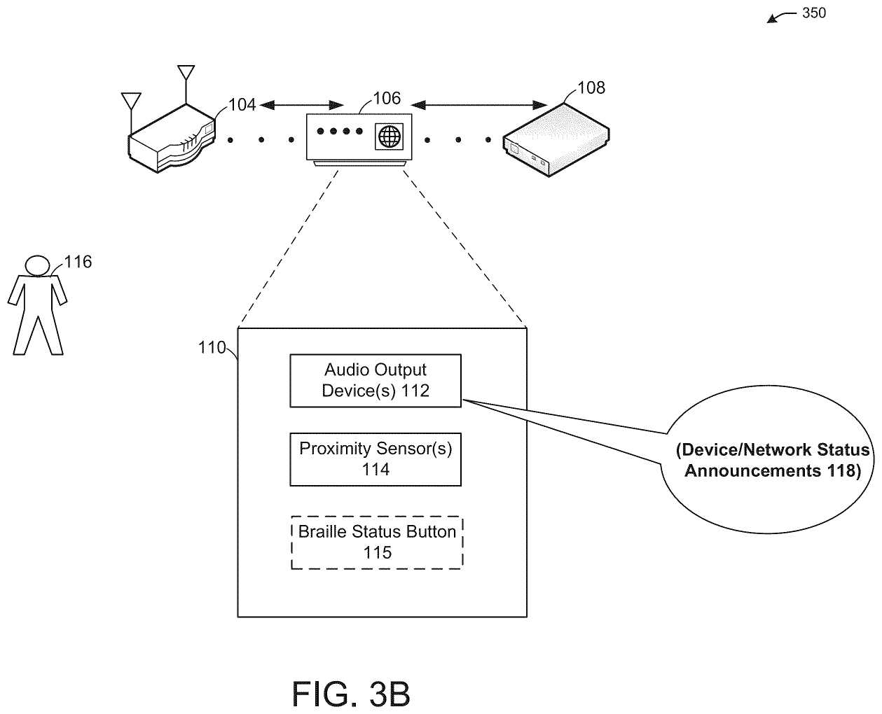

FIG. 3A illustrates an exemplary system 300 for collecting device and network status information and presenting device and network audio status announcements in accordance with one embodiment.

Referring to FIG. 3A, the system 300 may represent the system 100 of FIG. 1 in which the components 110 represent a separate device from the device 104, the device 106, and the device 108. In the system 300, the components 110 as a separate device may collect device and network status information from the device 104, the device 106, and the device 108, and may use the one or more audio output devices 112 to present the audio device/network status announcements 118, which may include status information for the device 104, the device 106, and the device 108 or networks used by/facilitated by those devices. The collection and/or presentation of the status information by the components 110 may be period and/or based on other triggering conditions such as proximity detection by the one or more proximity sensors 114, user requests from the user 116, and/or detection of status changes (e.g., a device being turned on or off, a connecting being established or dropped, a signal strength being below a threshold, a radio being active or inactive, Internet being detected, etc.).

FIG. 3B illustrates an exemplary system 350 for collecting device and network status information and presenting device and network audio status announcements in accordance with one embodiment.

Referring to FIG. 3B, the system 350 may represent the system 100 of FIG. 1 in which the components 110 are on-board one of the devices 102 of FIG. 1 (e.g., the device 106 as shown in FIG. 3B). In this manner, the device 106 having the components 110 may collect device and network status information from other devices (e.g., the device 104 and the device 108), and may detect its own connection, power, and/or network status. The collection and/or presentation of the status information by the device 106 may be period and/or based on other triggering conditions such as proximity detection by the one or more proximity sensors 114, user requests from the user 116, and/or detection of status changes (e.g., a device being turned on or off, a connecting being established or dropped, a signal strength being below a threshold, a radio being active or inactive, Internet being detected, etc.).

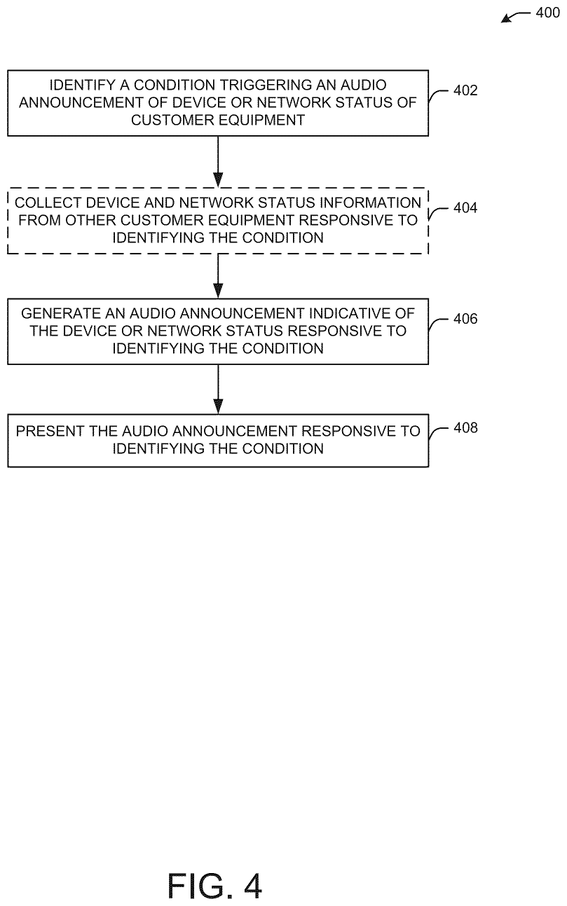

FIG. 4 is a flowchart illustrating a process 400 for presenting device and network audio status announcements in accordance with one embodiment.

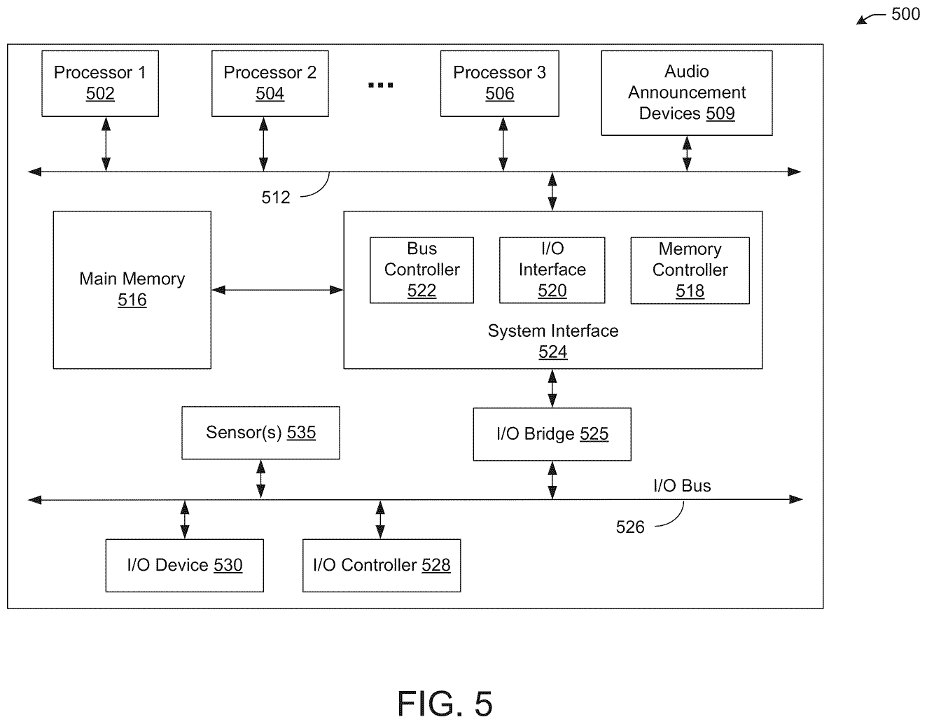

At block 402, a device (or system, e.g., the components 110 of FIG. 1, the audio announcement devices 509 of FIG. 5) may identify a condition triggering an audio announcement of device or network status of customer equipment, whether of the device or of another device that provides the device or network status information to the device. The condition may be a time period (e.g., period reporting), a proximity detection, a user request, and/or a detection of a change in status (e.g., device power status, a connection establishment or loss, presence of the Internet, activation or deactivation of a radio, or the like). The customer equipment may include at least one of a modem or a gateway.

At block 404, the device optionally may collect device and network status information from one or more other customer equipment responsive to identifying the condition. In this manner, identifying the condition may trigger the device to send a request to one or more other devices to provide the information, and the one or more other devices may respond by sending the requested information.

At block 406, the device may generate an audio announcement (e.g., the audio device/network status announcements 118 of FIG. 1) indicating device and/or network status, such as whether a device is on or off, whether a radio is active or inactive, whether a connection is present or disconnected, whether the Internet is detected, or the like. The audio announcement may include audio files that may be selected based on the status being announced, and generation of the audio announcement may include selection of an audio file.

At block 408, the device may present the audio announcement responsive to identifying the condition. In this manner, the condition may trigger presentation of the device or network status information so that a user who may not be able to see the status as indicated by lights on the device or another customer equipment, for example, may receive the status information. Presentation of the audio announcement may be through a speaker of the device. The device presenting the audio announcement may include the customer equipment whose status is being announced, or the customer equipment whose status is announced may be physically remote from the device.

It is understood that the above descriptions are for purposes of illustration and are not meant to be limiting.

FIG. 5 is a block diagram illustrating an example of a computing device or computer system 500 which may be used in implementing the embodiments of the components of the network disclosed above. For example, the computing system 500 of FIG. 5 may represent at least a portion of the devices 102, the components 110, and/or the remote resources 120 of FIG. 1, and discussed above. The computer system (system) includes one or more processors 502-506 and one or more audio announcement devices 509 (e.g., representing at least a portion of the devices 102, the components 110, and/or the remote resources 120 of FIG. 1, capable of performing any operations described with respect to FIGS. 1-4). Processors 502-506 may include one or more internal levels of cache (not shown) and a bus controller 522 or bus interface unit to direct interaction with the processor bus 512. Processor bus 512, also known as the host bus or the front side bus, may be used to couple the processors 502-506 with the system interface 524. System interface 524 may be connected to the processor bus 512 to interface other components of the system 500 with the processor bus 512. For example, system interface 524 may include a memory controller 518 for interfacing a main memory 516 with the processor bus 512. The main memory 516 typically includes one or more memory cards and a control circuit (not shown). System interface 524 may also include an input/output (I/O) interface 520 to interface one or more I/O bridges 525 or I/O devices with the processor bus 512. One or more I/O controllers and/or I/O devices may be connected with the I/O bus 526, such as I/O controller 528 and I/O device 530, as illustrated.

I/O device 530 may also include an input device (not shown), such as an alphanumeric input device, including alphanumeric and other keys for communicating information and/or command selections to the processors 502-506. Another type of user input device includes cursor control, such as a mouse, a trackball, or cursor direction keys for communicating direction information and command selections to the processors 502-506 and for controlling cursor movement on the display device. The I/O device 530 also may include a microphone for detecting voice commands, the one or more audio output devices 112, and/or the Braille status button 115. Sensors 535 may include the one or more proximity sensors 114.

System 500 may include a dynamic storage device, referred to as main memory 516, or a random access memory (RAM) or other computer-readable devices coupled to the processor bus 512 for storing information and instructions to be executed by the processors 502-506. Main memory 516 also may be used for storing temporary variables or other intermediate information during execution of instructions by the processors 502-506. System 500 may include a read only memory (ROM) and/or other static storage device coupled to the processor bus 512 for storing static information and instructions for the processors 502-506. The system outlined in FIG. 5 is but one possible example of a computer system that may employ or be configured in accordance with aspects of the present disclosure.

According to one embodiment, the above techniques may be performed by computer system 500 in response to processor 504 executing one or more sequences of one or more instructions contained in main memory 516. These instructions may be read into main memory 516 from another machine-readable medium, such as a storage device. Execution of the sequences of instructions contained in main memory 516 may cause processors 502-506 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 506 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 516, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed:

1. A device for presenting audio announcements of customer equipment status, the device comprising:
a speaker; and
memory coupled to at least one processor, the at least one processor configured to:
identify a condition triggering an audio announcement of device or network status of customer equipment, wherein the customer equipment comprises a modem or a gateway;
generate, based on the identification of the condition, the audio announcement; and
present, based on the identification of the condition, the audio announcement using the speaker.

2. The device of claim 1, comprising the modem or the gateway.

3. The device of claim 1, wherein the customer equipment is physically remote from the device.

4. The device of claim 3, wherein the at least one processor is further configured to:
receive the device or network status from the customer equipment.

5. The device of claim 4, wherein the at least one processor is further configured to:
send a request to the customer equipment to provide the device or network status of customer equipment,
wherein the device or network status is received responsive to the request.

6. The device of claim 5, wherein the request is sent responsive to the identification of the condition.

7. The device of claim 1, further comprising a proximity sensor, wherein the condition triggering the audio announcement comprises a proximity detection by the proximity sensor.

8. The device of claim 1, wherein the at least one processor is further configured to:
receive provisioning information from a remote resource; and
provision a proximity sensor based on the provisioning information.

9. The device of claim 1, wherein the condition triggering the audio announcement comprises a user request.

10. The device of claim 9, further comprising a button comprising a Braille indicator, wherein the user request comprises a touch of the button.

11. The device of claim 9, wherein the user request comprises a voice request.

12. The device of claim 1, wherein the triggering condition comprises a detection of a change in status of at least one of a device power, a connection between devices, or presence of the Internet.

13. A system for presenting audio announcements of customer equipment status, the system comprising:
a speaker;
customer equipment in a network; and
memory coupled to at least one processor, the at least one processor configured to:
identify a condition triggering an audio announcement of device or network status of the customer equipment, wherein the customer equipment comprises a modem or a gateway;
generate, based on the identification of the condition, the audio announcement; and
present, based on the identification of the condition, the audio announcement using the speaker.

14. The system of claim 13, wherein the device or network status comprises a status of a device comprising the speaker.

15. The system of claim 13, wherein the device or network status comprises a status of the customer equipment, and wherein the customer equipment is physically remote from the device comprising the speaker.

16. The system of claim 15, wherein the at least one processor is further configured to:
receive the device or network status from the customer equipment physically remote from the device comprising the speaker.

17. The system of claim 16, wherein the at least one processor is further configured to:
send a request to the customer equipment to provide the device or network status of customer equipment,
wherein the device or network status of the customer equipment is received responsive to the request.

18. The system of claim 17, wherein the request is sent responsive to the identification of the condition.

19. A method for presenting audio announcements of customer equipment status, the method comprising:
identifying, by processing circuitry of a device, a condition triggering an audio announcement of device or network status of customer equipment, wherein the customer equipment comprises a modem or a gateway;
generating, by the processing circuitry, based on the identification of the condition, the audio announcement; and
presenting, by the processing circuitry, based on the identification of the condition, the audio announcement using a speaker.

20. The method of claim 19, wherein the device comprises the modem or the gateway.
